(19) United States
(12) Patent Application Publication
(10) Pub. No.: US 2005/0183283 A1
(43) Pub. Date: Aug. 25, 2005

(54) Heating element and circuit for a hair management system

(75) Inventors: Walter R. Evanyk, Plano, TX (US); Shane R. Evanyk, Plano, TX (US)

Correspondence Address: JONES DAY, 77 WEST WACKER, CHICAGO, IL, 60601-1692, US

(73) Assignee: PowerPulse Technologies, L.P., Richardson, TX (US)

(21) Appl. No.: 11/055,235

(22) Filed: Feb. 10, 2005

Related U.S. Application Data
(60) Provisional application No. 60/545,783, filed on Feb. 19, 2004.

(51) Int. Cl. F26B 19/00; F25B 13/00

(52) U.S. Cl. 34/96; 34/91

(57) ABSTRACT

An improved method and apparatus for improving hair management devices, preferably portable devices, such as curling irons and hot air brushes by including novel heating elements and circuits. A novel elongated heat transfer hollow tube is formed of a metal that is preferable perforated with small holes and that heats and cools quickly such as copper, aluminum, or brass. The hollow tube has sufficient wall thickness for rigidity but is sufficiently thin to allow rapid heating and cooling. In addition, a novel heat source is formed with a light bulb, preferably halogen, located with said hollow tube that likewise heats and cools quickly. The light bulb is removable and replaceable in case of damage. A unique circuit automatically applies full power to the unit until it reaches the desired temperature and then allows a control circuit to automatically reduce the power applied to a value sufficient only to maintain the desired temperature. In the preferred embodiment, a bimetallic switch is coupled in parallel with the control circuit to allow full power to be applied to the heating source to obtain rapid heating of the hollow tube and then allows the control circuit to automatically reduce the power to an amount sufficient only to maintain the desired temperature of the hollow tube.

This application claims the benefit of Provisional Application, Ser. No. 60/545,783, filed Feb. 19, 2004.

### BACKGROUND OF THE INVENTION

1. Field of the Invention

The present invention relates in general to heating elements and circuits for hair management devices, preferably portable devices, such as hair curling irons and hot air brushes. In particular, the invention relates to novel heating elements and circuits that heat quickly and cool quickly, the heating element being formed with at least one light bulb as the heating element encased in a hollow elongated tube, the tube having perforations to allow radiant heating and well as conductive heating, and with a heating control circuit that utilizes a heat sensing device to prolong battery life by allowing the heating element to reach the desired temperature and then automatically reducing the applied power sufficient only to maintain the desired temperature.

2. Description of Related Art Including Information Disclosed Under 37 CFR §1.97 and 1.98

There are many different types of hair management devices such as curling irons and hot air brushes. To applicant's knowledge, the majority use alternating current and, therefore, are connected by cords that have an electrical plug that must be inserted into an AC voltage socket in order to operate. Some portable devices use accelerants such as Butane gas. Applicant is a co-inventor of the Portable Hair Dryer disclosed in U.S. Pat. No. 6,449,870, commonly owned and incorporated herein by reference in its entirety, and has pending applications related thereto.

However, applicant knows of no electrically operated hair management devices such as curling irons and hot air brushes that are portable.

Further, whether portable or non-portable, such existing hair management devices use an elongated tube made of a material such as steel and relatively thick aluminum and such material has a mass that requires long heating periods and cooling periods.

In addition, the heating elements themselves are of ceramic or other materials that are sandwiched between conductive metal plates that are in heat transfer relationship to the elongated metal tube. This construction requires heat transfer from the heating elements through electrical insulation, such as mica, to the conductive metal plates to the elongated metal tube. Such construction causes an increased time for the elongated metal tube to heat and to cool and causes inefficient operation of the device.

Also, in commonly owned U.S. Pat. No. 6,449,870, incorporated herein by reference in its entirety, there is disclosed a portable device with a circuit for prolonging the life of the batteries by using a pulser circuit that includes an oscillator, a shift register, and a temperature selector that selects a certain stage in the shift register. The selected stage enables only those pulses in the selected stage to be applied to the power transistor that drives the load, i.e. the heating element, to maintain the heat attained by the heating element without having continuous power applied thereto.

It would be desirable to have a hair management device such as a curling iron or a hot air brush that is preferably portable and that has a heating element with the ability both to quickly heat and cool with a power supply control circuit that is simple and small and that will enable the heating element to reach heat quickly and automatically maintain that heat with reduced power thereby conserving battery life. It would also be desirable to have the heat transfer tube be so constructed that it both heats and cools quickly once the power is removed.

### SUMMARY OF THE INVENTION

Thus, the present invention relates to an improved heating element and electrical control circuit for a hair management device such as a hair curler and a hot air brush and that enables efficient use of the power supply of a portable hair management device.

In typical fashion, the hair management device has a hollow non-heat conducting handle and an elongated heat transfer hollow tube associated with the hollow handle.

However, the improved heating element includes at least one light bulb as a heat source inside the elongated heat transfer tube. Preferably, the light bulb is a halogen bulb. The light bulb, as a heat source, heats very quickly and also cools quickly. This is desirable in hair management devices because the devices, as presently constructed, take a long period of time to reach the desired temperature and then, when power is removed, the devices take a long period of time to cool and, therefore, can be a source of burns for an unsuspecting or forgetful person. The novel use of an elongated light bulb, preferably a halogen bulb, as a heat source could also be advantageously used with existing AC devices that have a tubular structure as the heat transfer device.

In addition, the elongated heat transfer tube of the present invention may also be specially constructed to assist in enabling rapid heating of the device for transfer of the heat to the hair and then rapid cooling once the hair management is completed. Thus, the elongated heat transfer tube is formed of a material having quick heating and cooling characteristics. Such material may be found in the group consisting of copper, brass, aluminum, ceramic or any other material having the required heating characteristics and that is sufficiently thin while preserving structural integrity. As stated above, the elongated heat transfer tube may be any of the types presently used such as steel. However, such tube does not reach the desired temperature as quickly as the novel tube disclosed herein that is formed of a relatively thin material taken from the group consisting of copper, brass, ceramic, and aluminum.

To additionally assist the user in hair management, the novel heat transfer tube disclosed herein has a plurality of perforations therein to enable radiant energy from the light bulb, such as ultra-violet and infra-red rays, to be conveyed directly to the hair in addition to the conductive heat from the novel heat transfer tube. The perforations are preferably formed in a uniform pattern on the hollow heat transfer tube. The perforations or orifices may be of different sizes but should be sufficiently small to minimize the possibility of the hair of the user from becoming entangled therein. Obviously, the tube may be used without perforations, but the perforations enable the use of radiant heat and thus add a novel and useful feature for the user. The novel use of perforations could also be used with existing alternating current devices that have a tubular structure as the heat transfer device.

The novel light bulb may also be coated with a material such as a ceramic that not only conducts and radiates heat from the bulb but also provides some structural stability to the glass bulb and thus reduce the possibility of breaking or shattering the glass bulb easily.

Inasmuch as the light bulb will eventually burn out or be broken, it is made to be removable and replaceable. It may be mounted in a screw type base or in a bayonet type base, both well know in the art, or with any other type of mounting, for easy removal.

To facilitate removal and replacement of the light bulb, the novel hollow heat transfer tube may be removably attached to the hollow non-heat conductive handle so that it can be easily removed to expose the light bulb, or heat source and enable the light bulb to be removed and replaced.

Also, the light bulb or heat source may be resiliently mounted in the hollow heat transfer tube by supporting the light bulb at each end with a flexible device such as a coiled spring or other resilient device. This support will also assist in reducing shock damage to the light bulb from dropping the unit or from vibration of any kind.

Further, the novel heating element has an electrical control circuit associated with it that prolongs battery life, and heating element life, by applying maximum power to the light bulb or heat source until the heat source reaches the desired temperature and then reducing the applied power sufficient to only maintain the desired heat. The voltage amplitude does not change but the amount of time the voltage is applied to the load, the heat source or light bulb, changes thus changing the power applied. It has been found, in actual tests, that applying as little as 10% of the continuous maximum applied voltage may be sufficient to maintain the desired temperature. This novel control circuit could be advantageously used with existing alternating current devices to minimize power use.

To accomplish this novel battery saving operation, a heat sensor, such as a tempistor or thermistor, and preferably an LM 34 thermistor made by National Semiconductor, provides the proper control.

Thus, it is an object of the present invention to provide a novel hair management device such as a hair curler or a hot air brush that is portable and utilizes batteries to provide power to the device. The batteries may be in the handle of the device or in a battery pack coupled to the device with electrical connectors.

It is also an object of the present invention to provide a novel hair management device that both heats and cools more rapidly than corresponding existing devices.

It is still a further object of the present invention to provide a novel hair management device that utilizes at least one light bulb as the heat source inasmuch as a light bulb will both heat and cool rapidly. The light bulb is preferably a halogen light bulb.

It is yet another object of the present invention to encase the light bulb or other heat source in an elongated tube that conducts heat to the hair and that is made of a sufficiently thin material that has structural integrity and yet heats or cools rapidly such as brass, copper, aluminum, ceramic, or any other material having comparable heating and cooling requirements. The novel brass, copper, aluminum, or ceramic tubes could advantageously be used with existing devices using alternating current.

It is a further object of the present invention to form a plurality of perforations in the elongated tube to enable radiant energy from the light source to be applied to the hair of the user in addition to the conductive heat from the elongated tube itself. Again, such perforations could advantageously be used with presently existing alternating current hair management devices having a hollow tube with a heating element therein.

It is still another object of the present invention to construct the hair management device such that the light bulb, or heat source, may be easily replaced in the event it is broken or otherwise fails to operate.

In addition, it is an object of the present invention to provide a novel hair management device that conserves and prolongs battery life by having an electrical circuit that applies maximum power to the load or heat source, senses the heat of the heat source, or light bulb, and when the heat source is at the desired temperature, reduces the amount of time that the maximum voltage (power) is applied to the heat source thus prolonging both the battery life and the life of the light bulb or other heat source.

Thus, the present invention relates to an improved heating element and electrical control circuit for a hair management device comprising a hollow non-heat conductive handle, an elongated heat transfer hollow tube having an interior portion, the hollow tube being removably coupled to the hollow handle and preferably having a plurality of uniformly spaced perforations about the periphery thereof, a power supply, at least one light bulb, and preferably only one light bulb, in the interior portion of the elongated heat transfer hollow tube to heat the elongated heat transfer tube, the uniformly spaced perforations in said elongated hollow tube allowing both conductive heat and radiant energy from the heat source to be emitted outwardly of the elongated hollow tube, and an ON/OFF switch coupling the power supply to the light bulb to generate heat that is transferred to the elongated heat transfer hollow tube and radiated through the plurality of spaced perforations.

### BRIEF DESCRIPTION OF THE DRAWINGS

These and other features of the present invention will be more fully understood when taken in conjunction with the following Detailed Description of the Drawings in which like numerals represent like elements and in which:

FIG. 1 is a perspective view of a curling iron in which the novel invention is embodied;

FIG. 2 is a perspective view of a hot air brush in which the novel invention is embodied;

FIG. 3 is a cross-sectional view of the elongated heat transfer hollow tube used with the devices of FIG. 1 and FIG. 2 with a light bulb as the heat source in the interior thereof;

FIG. 4 is a cross-sectional view of the hollow non-heat conducting handle of the devices of FIG. 1 and FIG. 2 illustrating batteries in the hollow handle, the switches, electronic control circuit, and the contacts at the bottom of the handle for charging the batteries when the unit is placed in a holder;

FIG. 5 is a block diagram of the novel electronic control circuit illustrated in FIG. 4;

FIG. 6 is a detailed wiring diagram of the novel electronic control circuit of FIG. 5;

FIG. 7 is a wiring diagram of an alternate heat sensing circuit for use with the electronic control circuit shown in FIG. 5 and FIG. 6;

FIG. 8 is a graph illustrating the heating times for prior art curling iron with 110 volts rectified and applied to a heating element as a load;

FIG. 9 is a graph illustrating the heating time of the present invention when 12 volts is applied to a 12 volt halogen light bulb and no control circuit is involved (12 volts applied continuously to the load);

FIG. 10 is a graph illustrating the relationship of the heat sensor input and the sawtooth input to the control circuit comparator (in FIG. 5 and FIG. 6) and the output of the comparator in response;

FIG. 11 illustrates on possible light bulb heat source having multiple filaments;

FIG. 12 illustrates one version of a circuit that can be used to generate multiple temperatures with the light bulb heat source of FIG. 11;

FIGS. 13-15 illustrate one version of a temperature selector switch that could be used as the switch 18 in the circuit of FIG. 12;

FIGS. 16A, 16B, and 16C generally represent a unit for charging the batteries in a portable hair management device that illustrates a fail-safe switch that removes power to the OFF/ON switch of the hair management device so that the device cannot provide power to the heating element even when the ON/OFF switch is left in the ON position; and

FIG. 17 illustrates a circuit that will allow the use of a light emitting diode to indicate that power is being applied to the control circuit.

### DETAILED DESCRIPTION OF THE INVENTION

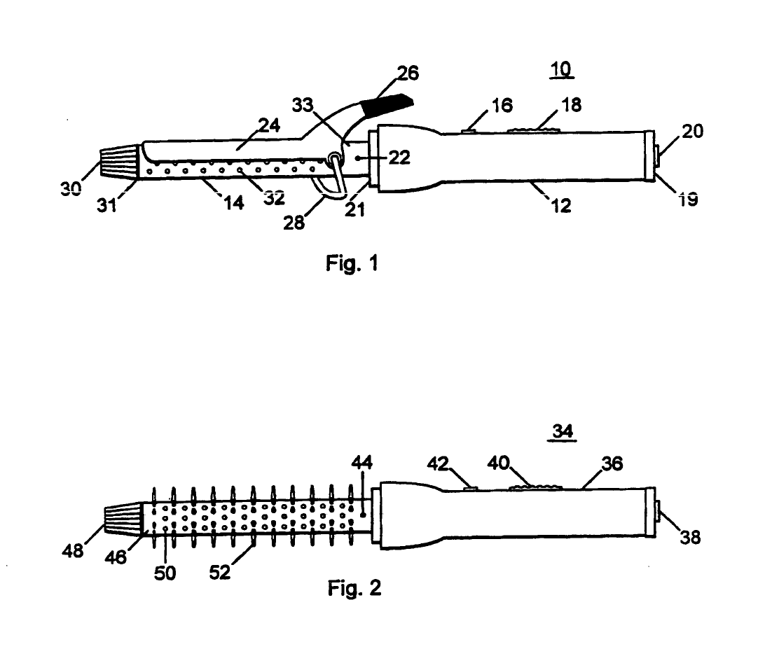

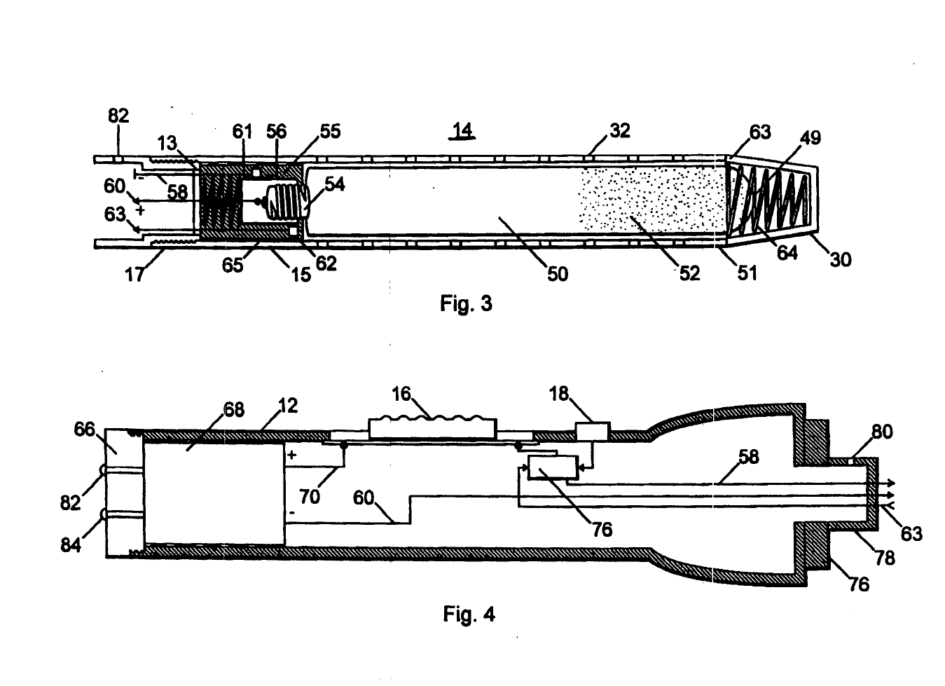

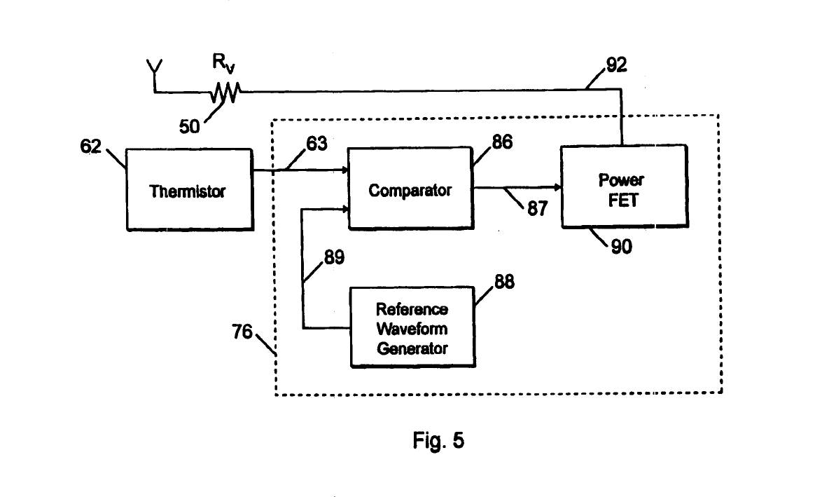

FIG. 1 is a perspective view of a curling iron 10 that embodies the present invention. The curling iron 10 is comprised of a handle portion 12 having a bottom end 19 and a top end 21, the handle portion 12 being non-heat conducting to enable it to be held by the user, and a hollow elongated heat transfer tube 14 that has an interior portion in which a novel heat source is provided in the form of a light bulb 50 (shown in FIG. 3), an outer end 31 and an inner end 33 that is removably coupled to the top end 21 of the handle portion 12 in any well-known manner such as by threads, screws, removable pins, and the like at point 22. A conventional hair engaging plate or arm 24 is pivotally coupled to the hollow heat transfer tube at the pivot points of the rest support 28 and is pivotable away from and toward the hollow heat transfer tube with the use of thumb rest 26 in a conventional manner. Handle portion 12 also includes an OFF/ON switch 16 and a heat temperature selector switch 18. Also, electrical contacts 20 at the bottom end 19 of the handle portion 12 allow the batteries in the handle 12, shown in FIG. 4, to be charged when placed in a device charging holder in a well known manner when the device is not in use. One skilled in the art will realize that the batteries could be in a separate pack and connected to the device by electrical connectors.

A cap 30 is removably attached to the outer end 31 of the elongated heat transfer hollow tube 14. Also, an additional novel feature of the present invention is shown in FIG. 1 as perforations or orifices 32 in the elongated heat transfer hollow tube 14 that extend through the wall of hollow tube 14 wall to enable radiant energy from the light bulb 50 to be applied to the hair of the user. As stated, the novel perforations could be used in existing like devices that use AC current but they would not be portable.

Further, the novel elongated hollow heat transfer tube 14 is further improved by forming it of a material that both heats rapidly and cools rapidly such as any material from the group consisting of brass, copper, ceramic, and aluminum. The shell or cylindrical wall that forms the hollow tube 14 may have any desired thickness but the preferred range is from about 0.010 inches to about 0.040 inches; however, it is to be understood that the thicker the wall, the longer the time required to heat and to cool the hollow tube and the thinner the wall, the less structural integrity is obtained. The preferred thickness of the copper, brass, ceramic, and aluminum wall forming the hollow tube 14 is about 0.030 inches. To applicants knowledge, no prior art hair management devices use a hollow metal tube formed from the group consisting of copper, brass, ceramic, and aluminum and having a thickness in the range of from about 0.010 inches to about 0.040 inches. Also, any other type of material, such as steel, stainless steel, and the like, could be used to form the hollow tube. However, again, these materials require a longer time period both to heat and to cool. They work very well, however, with the novel heat source as a light bulb on the interior thereof. Again, such brass and like material set forth above could also be used advantageously in forming the tube structures of presently existing like devices that use AC voltage though, again, they would not be portable.

FIG. 2 is a perspective view of a hot air brush 34 that embodies the present invention. Again, it embodies a hollow handle portion 36 for holding the battery or batteries and has contacts 38 at the base thereof for placing the device in a holder for charging the battery or batteries located in the handle 36 in a well-known manner. An OFF/ON switch 42 and temperature control switch 40 are also placed in the handle 36 along with electronic control circuit 76 (shown in FIG. 4).

An attachment point 44 allows the elongated hollow tube (similar to tube 14 in FIG. 1) to be attached thereto. A hollow, selectively rotatable, brush portion 46 is mounted over the elongated hollow tube and attached thereon with the cap 48. Again, orifices or perforations 32 are formed in the brush portion 46 to allow radiant energy from the novel heat source or light bulb 50 (shown in FIG. 3) to be emitted. Bristles 52 extend outwardly in a perpendicular relationship to the brush portion 46 as is well known in the art.

The operation of the hot air brush heating element and circuit is similar in function to that of the curling iron shown in FIG. 1 except, of course, that the hot air brush also has a small fan in the handle to blow the heated air generated by the novel heat source, the light bulb, through the orifices or perforations 49 in the brush to dry the hair while brushing it.

The elongated hollow heat transfer tube 14 of FIG. 1 is shown in cross-section in FIG. 3.

An end cap 30 is attached in any well-known manner (not shown) to the hollow tube 14 such as by threads, clips, snaps, and the like.

A plurality of orifices 32 are illustrated to radiate energy that is generated by the heat source 50 located in the interior of the novel hollow tube 14. It is believed that, in addition to conductive heat, the radiant energy from the novel heat source 50 that passes through the orifices 32 will help to heat the hair without damaging the hair. Also, the diameter of the orifices 32 may vary but should be sufficiently small to avoid the possibility of the hair of the user becoming entangled therein. Further, the material forming the hollow tube 14 may be of any known type of heat conductive material. However, in the preferred embodiment, the material is relatively thin as explained previously and is from the group consisting of aluminum, brass, ceramic, and copper. The preferred thickness of the preferred materials set forth above allows the material to heat extremely rapidly and in like manner to cool very quickly in contrast with the conventionally used materials as stated previously. In addition, the outer surface of the novel hollow tube 14 may be improved esthetically by plating the outer surface with a plating material such as chromium, ceramic, enamel, or the like, not shown in the drawing for simplicity but which are well known in the art.

The novel heat source is shown in FIG. 3 to be light bulb 50 that is located within the interior of the hollow tube 14. The heat source could be of any known type but, as stated earlier, a light bulb heats up extremely rapidly and, in like manner, cools down extremely fast thus forming a novel and attractive heat source. For the most efficient heating, it is important to match the voltage of the light bulb to the voltage source as will be explained hereafter.

At least a portion of the light bulb 50 may be coated with a ceramic material, shown partially at 52 in FIG. 3, for the purpose of providing structural integrity. Thus, the coated glass bulb 50 provides some reduction in the possibility of the glass bulb 50 to shatter under unexpected shock or stress. Such coating 52 also enables heat from the light bulb 50 to be transferred to the hollow tube 14 and also enables radiant energy to be transferred through the perforations or orifices 32 in the hollow tube 14 externally thereof.

The light bulb 50 may of course eventually burn out, be broken, or otherwise fail to function. In such case, the light bulb (novel heat source 50) should be made replaceable. This function may be accomplished by removably attaching the base 15 of the hollow tube 14 to the handle portion 12 (shown in FIG. 4) in any well-known fashion. Such function may be accomplished in any number of well-known ways such as by threadedly attaching the hollow tube base 15 to a connector unit 17 with threads 65. Thus, the hollow tube may be unthreaded from the connector unit 17 to expose the light bulb 50. Light bulb 50 may then be removed and replaced as by placing a typical threaded base 54 on the light bulb 50 and threadedly screwing it into electrical base 56 in connector unit 17. Appropriate electrical connections 58 and 60 may carry current to and from the light bulb 50.

Of course there are any other numbers of ways of enabling the light bulb 50 to be removably replaced such as by forming the electrical base 56 as a bayonet type to match a corresponding bayonet type of base on the light bulb 50. The light bulb 50 may then be inserted into the electrical base and twisted to lock it in place as is well known. Also, the outer end 49 of the light bulb 50 could be made to extend outwardly beyond the outer end 51 of the hollow tube 14 sufficiently far under cap 30 to enable the cap 30 to be removed, the light bulb 50 grasped, removed, and replaced as described above in a well known fashion.

Because the light bulb 50 in the hair management device is subject to breakage because of physical shock that may be unexpectedly applied to the unit, it is desirable that the light bulb 50 be protected from such shock. This may be accomplished in a number of ways, one of which is shown in FIG. 3.

A shock absorbing element is associated with the light bulb 50 to provide the desired protection from physical shock damage to the bulb 50. This protective device is shown in FIG. 3 to be a first resilient device 64 under and contained by the outer cap 30 and a second resilient device 61 in the connector unit 17. The first resilient device 64 is associated with the outer end 49 of the light bulb 50. The first resilient device 64 is shown as a coiled spring under cap 30 in FIG. 3 for simplicity of presentation but one skilled in the art would recognize that other types of resilient devices could also be used.

The second resilient device 61 is also shown to be a coiled spring that is associated with base 56 (into which the base of the light bulb 50 is threaded or otherwise makes electrical engagement) and also is associated with the plate 13 which may be located in the connector unit 17 (or in the base 15 of hollow tube 14). Thus the light bulb 50 is resiliently supported between the two resilient devices 61 and 64. Again, one skilled in the art would recognize that other types of resilient devices could be used other than coiled springs.

A heat sensor 62 is shown in the cavity 55 formed by the junction of the base 15 of the hollow tube 14 and the connector unit 17 by threads 65. This heat sensor 62 is placed so as to be in heat sensing proximity with the light bulb or heat source 50. For purposes of simplicity, only one conductive lead 63 is shown connected to and extending from heat sensor 62. However, some thermistors have two leads and, in the case of the preferred embodiment, the LM34 thermistor is used and it has three conductive leads attached thereto. It will be recognized by one skilled in the art that heat sensor 62 generates an output signal on conductive leads 63 that is proportional to the sensed heat. Obviously, the closer the heat sensor 62 is to the heat source 50 (the light bulb), the faster an output signal will be generated by the heat sensor 62. Inasmuch as the generated output signal from the heat sensor is used to control the amount of power applied to the heat source 50 (as will be explained in detail hereinafter), it will be recognized by those skilled in the art that the further away from the heat source 50 the heat sensor 62 is placed, the longer period of time will be required before an output control signal will be generated. This can be important because it is desirable that the heat source reach its maximum temperature as quickly as possible before input power is reduced to a point sufficient only to maintain the maximum temperature. This feature of course enhances the novel heating element and control circuit because the user of the hair management device experiences rapid heating and does not have to wait an inordinate amount of time before the device can be used. One skilled in the art can determine, without undue experimentation, the optimum location of the heat sensor unit 62 for any desired temperature.

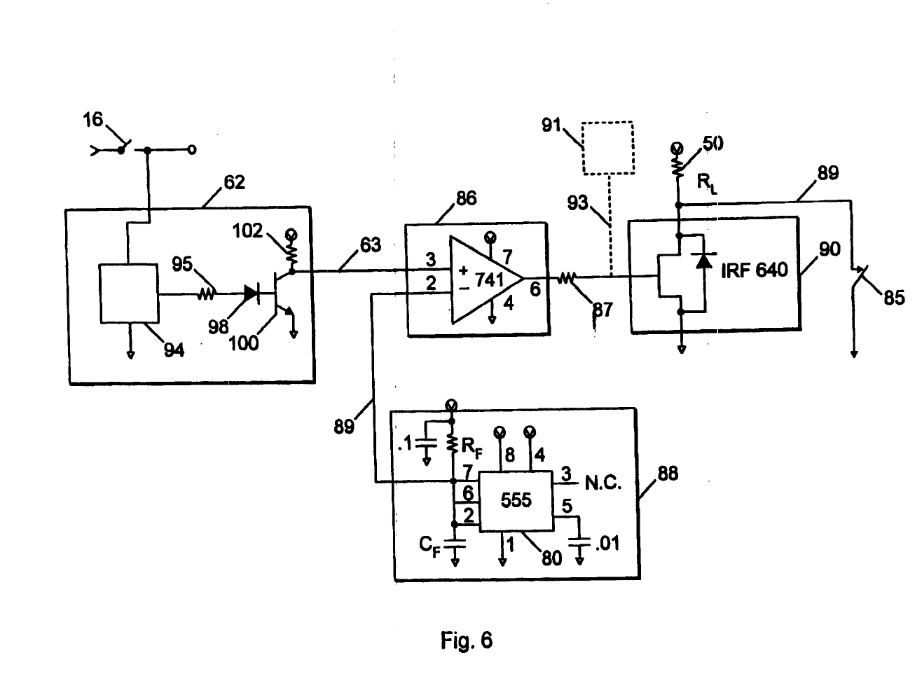

Of course, other means can be used to provide rapid heating as disclosed in commonly owned U.S. Pat. No. 6,449,870. There, as shown in FIG. 5B, a circuit comprising a comparator 70 and inverting diode 73 is used to maintain maximum power applied to the heat source by applying a continuous gating signal to transistor 66. When a reference voltage level 72 equals the feedback voltage from the heat sensor 68, the comparator generates a signal that is inverted by diode 73 and the continuous signal that was applied to the base of transistor 66 is removed. A pulser circuit 80, shown in detail in FIG. 5C, then takes control to maintain a desired heating source temperature. This circuit or the like could be used with the present invention as explained hereafter. Also, a bimetallic switch can be used to by-pass the control circuit to cause rapid heating until the operative temperature is reached as will be explained hereafter in relation to FIG. 6.

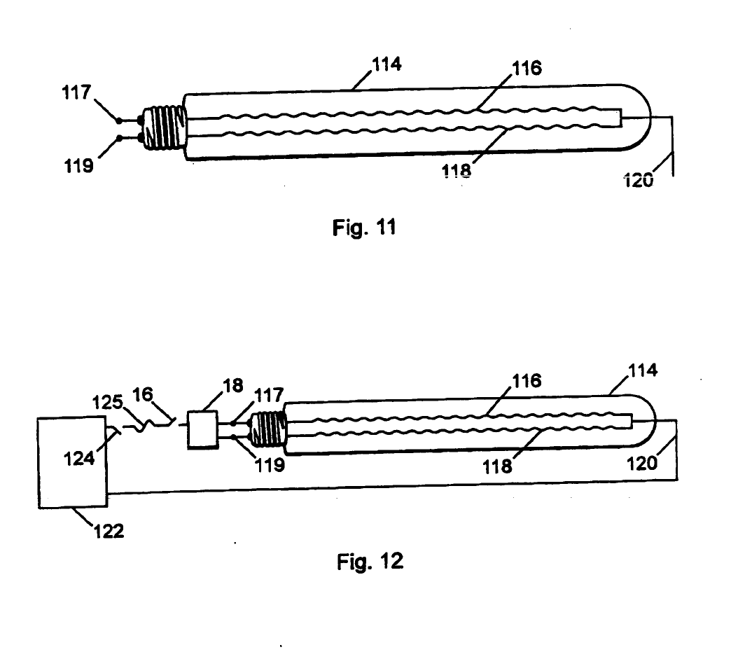

In addition, various heating temperatures could be selected with the use of a multifilament light bulb. For example, if a bulb with two filaments (similar to a high beam, low beam automobile headlight bulb) of different power levels is used, a high temperature can be obtained by energizing both filaments simultaneously. If a lower temperature is desired, only one if the two filaments is energized. Thus, three different temperatures could be selected. The first (high) when both filaments are energized simultaneously, the second (medium) when only one of the filaments is energized, and the third (low) when the other one of the filaments is energized. Thus, heat temperature selector switch 18, shown in FIG. 1, can have a first position that is HIGH, a second position that is MEDIUM, and a third position that is LOW heat. Thus, three temperatures can be selected by switch 18. See explanation of FIGS. 11-16, infra.

FIG. 4 is a detailed cross-section of the handle portion 12 of the present invention. As stated earlier, the handle portion 12 is formed of a non-heat conductive material as is well known in the art. Preferably within handle 12 is a battery or batteries 68 that generate an output voltage on lines 60 and 70. The voltage of the battery or batteries may be of different values depending upon the desired heat output from the hair management device. Applicant has used 7 batteries, each of 1.2 volts, in series to obtain 8.4 volts and 8 serially connected batteries, each of 1.2 volts to obtain 9.6 volts. These batteries are manufactured by Panasonic and each produces 2,250 milliampere hours of power. In addition, applicants have used 6 batteries, each of 2 volts, in series, to generate 12 volts to be applied to the load. These batteries are manufactured by Hawker Energy and each produces 2,500 milliampere hours of power. All of the above batteries were found to provide ample power to the heat source 50 to provide sufficient heat output.

It is to be understood that any type of rechargeable cells can be used although nickel-metal hydride (Ni-Mh) batteries are preferred because of power density and no memory effects among other benefits. It is preferred to match the applied voltage to a load designed for that voltage. Thus, it is more efficient to apply 12 volts to a 12 volt (or less) load (light bulb), 9.6 volts to a 9.6 volt (or less) load, and 8.4 volts to an 8.4 volt (or less) load. The batteries may be recharged when not in use through contacts 82 and 84 formed in the base 66 of the handle 12 to allow the unit to be placed in a charger in a well-known manner when not being used. Such chargers are so well-known in the art for items such as portable telephones, portable toothbrushes, and the like that none is shown here. An example will be shown hereafter in relation to FIGS. 18A, 18B, and 18C.

The output of the battery or batteries 68 on line 70 is coupled to an OFF/ON switch 16, also well-known in the art. The output of switch 16, when in the ON position, couples battery 68 to a control circuit 76 that will be described in more detail hereinafter.

Also coupled to the control circuit 76 is a temperature setting control 18 (e.g. High, Medium, and Low) and the feedback signal from the heat sensor unit 62 (shown in FIG. 3) on lines 63. One skilled in the art knows how to connect such switch to the circuit 76 such as, for example only, by means of resistor networks that provide various voltages to the control circuit 76 to obtain various heating levels. Also, the switch 18 can couple battery power to a light bulb having multiple filaments as described earlier. The output of the control circuit 76 on line 58 and the negative output from battery 68 on line 60 are coupled to the heat source (light bulb) 50 as shown in FIG. 3.

Handle 12 may be coupled to hollow tube 14 in any desired manner understood by one skilled in the art. One way to connect them is to make the inside diameter of handle extension 78 sufficient for close fit with the connecting unit 17 shown in FIG. 3.

By placing orifice 82 in connecting unit 17 in alignment with the orifice 80 in the handle extension 78, a screw, or other fastener, may be inserted within orifices 80 and 82 to hold the handle 12 to the hollow tube 14 by means of connecting unit 17. Obviously, there are many other ways in which the handle 12 may be attached to the hollow tube 14.

FIG. 5 is a block diagram illustrating the operation of the control circuit 76. The general operation of the circuit will be described first. The control circuit 76 is coupled, as stated, between the OFF/ON switch 16 (shown in FIG. 4) and the heat source or light bulb 50 to supply power to the heat source to obtain a desired temperature and then the control circuit 76 limits the power applied to an amount sufficient only to maintain the desired temperature of the heat source thereby extending the life of both the light bulb and the batteries.

As can be seen in FIG. 5, the control circuit 76 comprises a comparator 86 having a first signal input 63 and a second signal input 89. The signal input 63 to comparator 86 is from thermistor 62 which is in heat sensing proximity to the heat source or light bulb 50 for generating an output signal proportional to the sensed heat. A reference signal generator produces an output that varies in amplitude with time such as a sawtooth generator. Such sawtooth generator 88 has its sawtooth output signal on line 89 coupled as the second input to the comparator 86. The comparator 86 produces an output signal on line 87 ONLY during the period of time in which the heat sensor output signal on line 63 (as the first input to the comparator 86) is greater in amplitude than any portion of the sawtooth wave form signal 89 at the second comparator input.

An electronic switch 90 is coupled between the comparator output on line 87 and the load 50 by means of conductor 92. The electronic switch 90 is preferably a semiconductor device such as a FET (field effect transistor) that is a power transistor capable of carrying the load current delivered to the load or light bulb 50. It is to be understood that the term “electronic switch” as used herein is intended to represent any automatic (as distinguished from “manual”) on-off switch including a mechanical relay switch. Thus, as the load 50 heats, the temperature is sensed by the thermistor 62 which generates a feed back signal on line 63 to the control circuit 76. As stated earlier, one skilled in the art will place the thermistor 62 at a distance from the light bulb 50 such that substantially maximum heat can be reached by the load 50 before the thermistor begins to send back a control signal.

Heat sensing units such as thermistors and tempistors, or any other device that generates a signal in response to a temperature change, may be used in the present invention. In the case of an LM34 thermistor, the preferred thermistor in the present invention, a voltage output is generated with an increase of heat applied to it. The maximum voltage output of comparator 86 (caused by the heat sensor or thermistor 62 at ambient temperature) is set, by amplifier or otherwise, to a point greater than the maximum value of a reference voltage whose magnitude varies with time (such as a sawtooth voltage or a voltage sine wave) to obtain maximum heating of the heat source 50.

As the thermistor 62 detects the heat generated by the heat source 50, the output voltage from transistor 100 begins to fall. As long as the value of the amplified thermistor output signal on line 63 is greater than the maximum voltage value of the reference waveform (such as a sawtooth or sine wave) as provided on line 89, maximum power is applied to the heat source. Thus, the comparator generates an output signal only in the time period during which the signal at the first comparator input caused by the heat sensing element is greater in amplitude than any portion of the reference signal at the second comparator input.

When the voltage value of the thermistor output signal intersects the reference waveform voltage, the comparator 86 produces an output signal ONLY during the time period when the reference voltage is lower in amplitude than the sensor voltage signal.

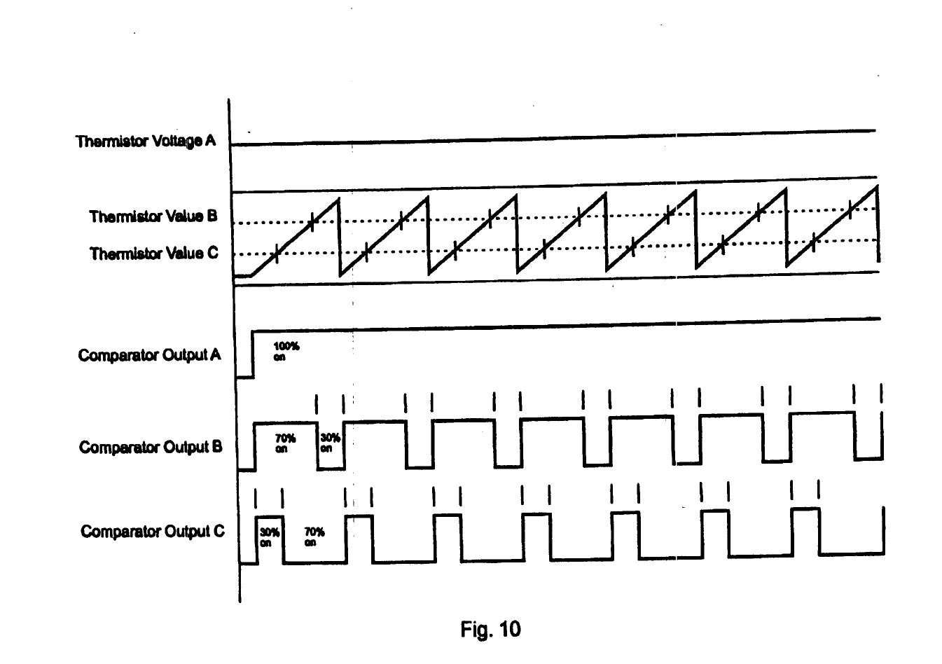

FIG. 10 illustrates this operation. The output signal A waveform caused by the thermistor and the reference signal (in this case a sawtooth waveform) are both illustrated in bold lines. As can be seen, when the amplitude of the output signal A is greater than the maximum amplitude of the sawtooth signal, the comparator generates a command signal to the FET that is continuous as shown by the comparator output waveform A. That is, continuous power is applied to the load, or light bulb, 50.

However, when the output signal caused by the heat sensor (e.g. thermistor) is at level B, the comparator generates an output signal ONLY during the time period in which the signal caused by the heat sensor is greater than any portion of the reference (sawtooth) signal. Thus comparator output curve B illustrates that the comparator is ON and generating an output signal to the FET switch ONLY about 70% of the time and is OFF about 30% of the time. This means of course that only 70% of maximum power is being supplied to the load.

When the output signal of the comparator caused by the heat sensor is at level C, comparator output waveform C shows that the FET is turned ON only about 30% of the time and the FET is turned OFF about 70% of the time.

From these graphs, it will be realized that if the heat sensor is placed at such a distance from the heat source so as to require more time to begin detecting heat, a longer period of time will exist when 100% output of the comparator will occur. On the other hand, if the thermistor or heat sensor is placed very near the heat source, it will begin to generate a signal almost immediately and the feedback signal from the heat sensor will begin almost immediately to reduce the power applied to the load.

With the circuit discussed earlier as set forth in commonly owned U.S. Pat. No. 6,449,870, a maximum power can be applied to the load and then the feedback signal from the heat sensor can be used to maintain the load temperature with reduced power applied. Such circuit is illustrated in FIG. 6 by block 91 and connecting line 93, both in phantom lines. In the alternative, a multiple filament light bulb could be used as explained previously.

In the circuit of FIG. 6 showing the circuit details of FIG. 5, a preferred embodiment of the rapid heat control circuit is shown. This embodiment can be used advantageously in both AC and DC (or portable) devices. A bimetallic switch 85 is shown paralleling the FET 90 and is coupled by line 89 from a point between the Power FET 90 and the load 50 (the light bulb) to ground potential. When the power switch 16 is activated, battery power is coupled to each element in the circuit.

Inasmuch as the bimetallic switch 85 is normally closed, current through the load 50 by-passes the FET 90 on line 89 and goes to ground. Thus, full power is applied to the load. It is well known that a bimetallic switch will open at some predetermined temperature because of the two dissimilar metals that form the switch. For example, a bimetallic switch used in a prior art hair curling iron, when tested three times, opened at 121° C. (249° F.), 124° C. (253° F.), and 129° C. (269° F.). The bimetallic switch tested then closed again at temperatures of 53° C. (127° F.), 50° (122° F.), and 51° C. (123° F.). These are acceptable variations but, in this instance, the temperatures are too high for the hair management devices disclosed herein and the bimetallic switch should be manufactured to open at a particular temperature and to reclose at a desired temperature. If the bimetallic switch 85 is set to open at a desired predetermined temperature that is NO MORE THAN 20° below the maximum heat desired to be achieved, the control FET will no longer be bypassed and its output, controlled by the temperature control circuit 86 as explained previously, will bring the temperature to the desired level and then reduce the power applied to that necessary to simply maintain that desired temperature as explained previously. This novel circuit allows a rapid heating of the load or light bulb 50 as just explained.

It will be recognized by those skilled in the art that the unit (hair curler and hair dryer) discussed herein could be placed in a receptacle for using AC wall voltage to heat the unit to the desired temperature and then disconnecting the unit from the AC power source and connecting the internal batteries directly to a heating element within the unit to form a portable unit that maintains the temperature. Clearly the batteries will not last as long as when used with the novel pulsing circuit disclosed herein but they will last longer than if they are used to not only maintain the temperature but also to heat the iron to the desired temperature.

Further, the bimetallic switch 85 shown in FIG. 6 could be used with the batteries as an elementary circuit to control or regulate the battery output to the unit when it is being used as a portable unit. It will be recognized by those skilled in the art that without the novel pulsing circuit shown in FIG. 6, after the iron reaches the set point temperature of the bimetallic switch 85 under the application of external AC power, the bimetallic switch 85 would open and prevent power from being applied to the load. When the unit is removed from the AC power source, the batteries only will be automatically connected to the bimetallic switch 85 and the heating element. When the temperature of the unit drops below a preset temperature controlled by the bimetallic switch, the bimetallic switch closes once again and the battery power is connected to the heating element to maintain the desired temperature as determined by the bi-metallic switch 85.

Again, the batteries will not last as long as when used with the novel pulsing circuit but they will last longer than they would if they were required to not only maintain the desired temperature but also to initially heat the unit to the desired temperature.

The heat sensing circuit 62 comprises, in the preferred embodiment, an LM34 thermistor 94 heat sensor made by National Semiconductor. It has a power input, a ground connection, and a signal output. The output signal is coupled through resistor 95 and isolation diode 98 to the base of operational amplifier 100 that is a well-known 2222A transistor. Power to transistor amplifier 100 is provided by switch 16 through load resistor 102. The ambient signal output of thermistor LM34 is very small, just millivolts, and thus amplifier 100 provides a corresponding output with a maximum voltage near power supply voltage at ambient temperature.

As the thermistor LM34 senses heat, its output signal begins to increase and the conduction of transistor 100 begins to increase and the voltage at the junction of load resistor 102 and the comparator input pin 3 on line 63 begins to decrease from its maximum value. The value of the output of the transistor 100 on line 63 is compared by comparator 86 with the value of the reference (sawtooth) waveform from generator 88 on line 89 to pin 2 of comparator 86. The comparator 86 is formed with an LM741 IC chip well-known in the art. The reference waveform, preferably a sawtooth waveform generator 88, is formed with a 555 IC chip that is also well-known in the art.

Thus, the FET 90, a well-known IRF640 power transistor, begins to conduct for shorter periods of time and the power to the load is reduced as explained earlier with the waveforms in FIG. 10. Resistor 87 couples the output signal from comparator 86 to the gate of the FET 90.

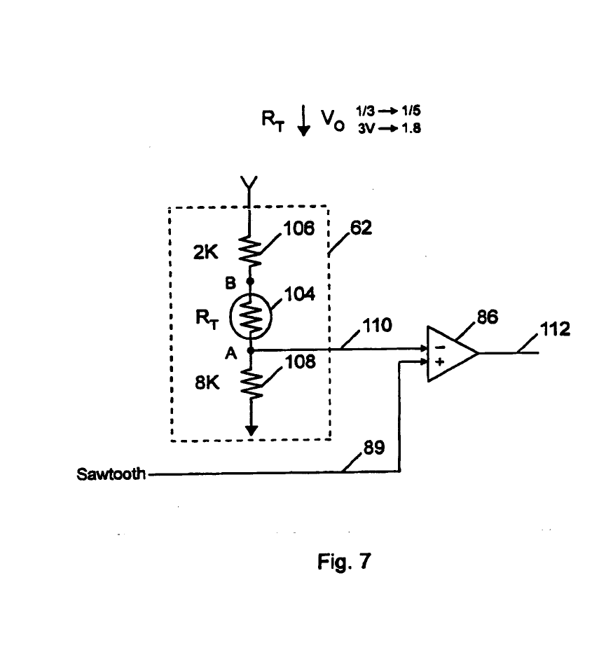

FIG. 7 illustrates an alternate heat sensing circuit 62. In this case, a two terminal thermistor 104 known in the art as NTC GE-73 Digikey Part No. KC00HG-ND is used as the heat sensor. Resistors 106 and 108 properly bias the thermistor 104. In the embodiment constructed, the thermistor 104 had an ambient resistance of 2,000 ohms, resistor 106 had a value of 2,000 ohms, and resistor 108 had a value of 8,000 ohms. As the thermistor 104 is exposed to heat, its resistance value begins to decrease and the voltage on line 110 to comparator 86 begins to decrease. This input on line 110 is once again compared to the sawtooth signal on line 89. The output of the comparator on line 112 is then used to control FET 90 as described earlier with respect to the use of the LM34 thermistor. Of course, the circuit may be modified to enhance voltage outputs as desired. Such design is well-known to those skilled in the art and will not be further explained here.

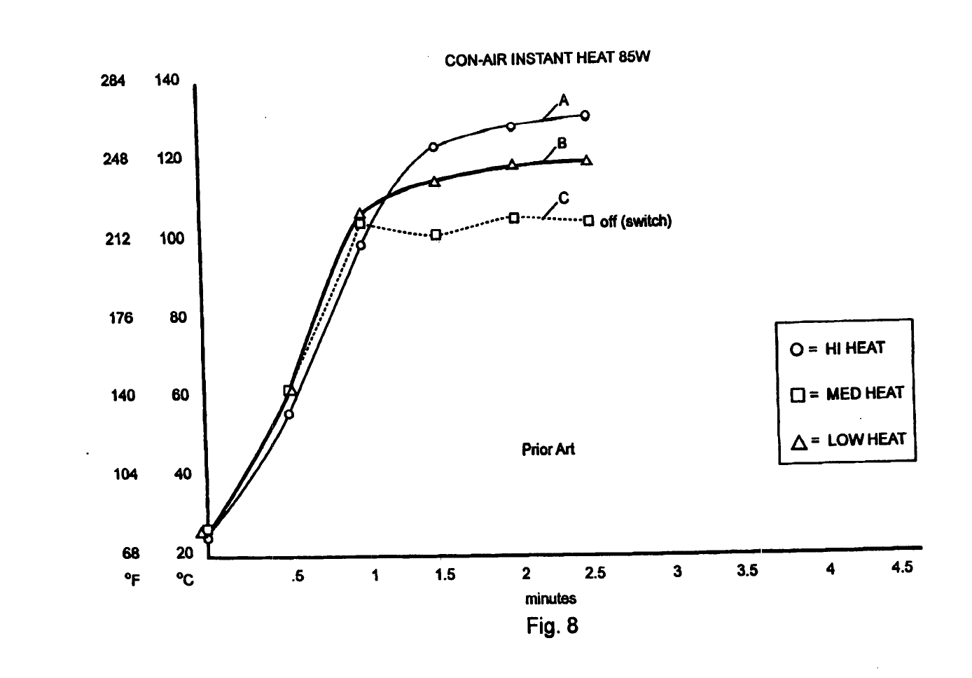

FIG. 8 is a graph illustrating the heating of a prior art 110 volt AC curling iron. Measurements were taken at HIGH, MEDIUM, and LOW heat settings. This curling iron was said to provide “instant” heat. Curve A illustrates the heating of the tube with the HIGH temperature setting. It can be seen in Curve A that a temperature of about 100° C. (212° F.) was reached in one minute. Maximum on the HIGH setting was about 130° C. (266° F.). Curve B, representing the MEDIUM temperature setting, shows that the prior art curling iron reached 106° C. (223° F.) in one minute with a maximum temperature reached of about 118° C. (244° F.). Curve C shows that the prior art curling iron reached about 104° C. (219° F.) in one minute with a maximum temperature reached of about the same temperature.

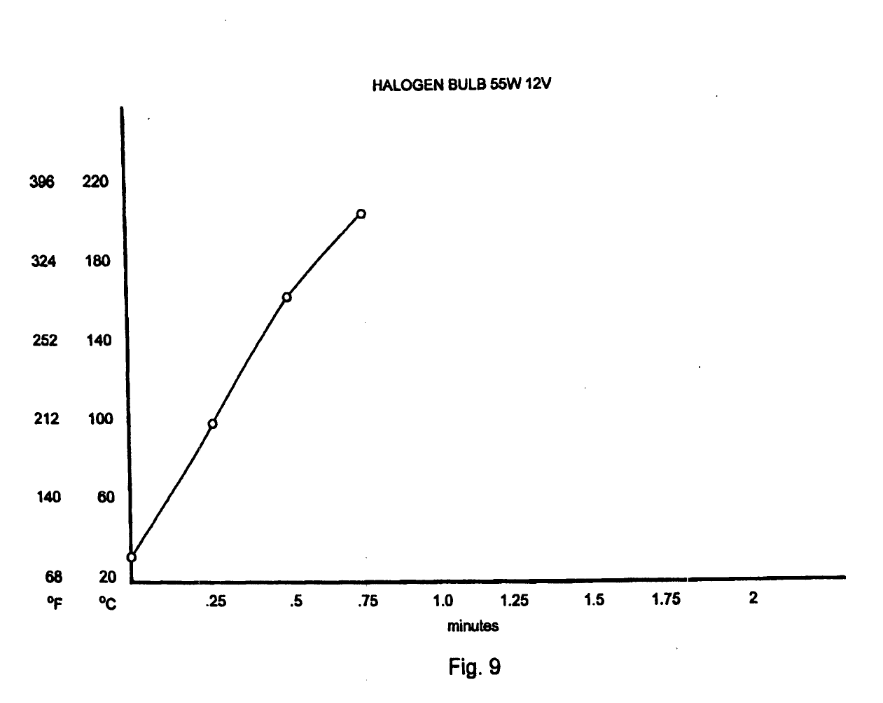

FIG. 9 illustrates the rapid heating capabilty of the novel circuit of the present invention when a circuit is used to continuously apply full voltage to the heating source (light bulb 50). The curve illustrates the heating that occurs when 12 volts is applied to a 12 volt light bulb 50 as the load. The halogen light bulb was about 1 inch in length encased in a brass heat source having perforations. It can be seen that a temperature of 96° C. (205° F.) was reached in 15 SECONDS, a temperature of 160° C. (320° F.) was reached in 30 SECONDS, and a temperature of 206° C. (368° F.) was reached in 45 SECONDS. It should be understood that when using an 8.0 volt halogen light bulb with 8.0 volts applied, the heating curve generated substantially matches the heating curve shown in FIG. 9 when the 12 volt halogen bulb was being supplied with 12 volts.

Clearly, whatever voltage supply value is used, heating occurs much more rapidly than the prior art curling iron when full, continuous, voltage is supplied to the halogen light bulb load as would be the case when a rapid heating circuit is added.

FIG. 11 illustrates a multifilament light bulb as discussed previously. This light bulb may by a traditional incandescent bulb or a halogen bulb. The halogen bulb heats much faster than the incandescent bulb and heats the hollow tube to a much higher temperature. The bulb 114 shown in FIG. 11 has at least two filaments shown as 116 and 118 in FIG. 11. They receive power selectively at terminals 117 and 119 respectively at one end while both of the other ends are connected to ground potential by conductor 120.

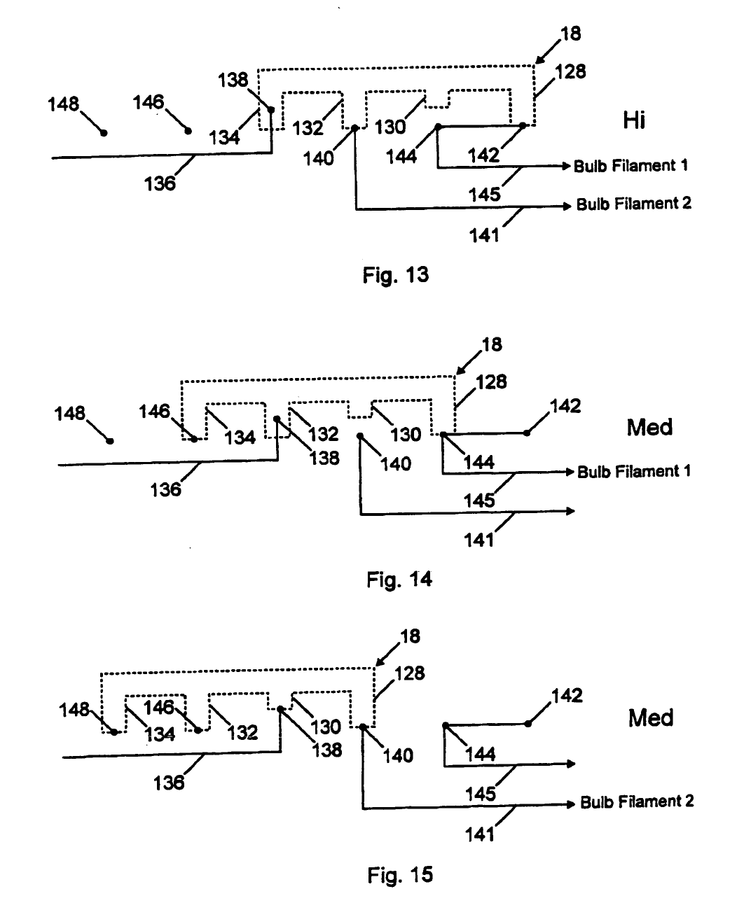

FIG. 12 is a circuit diagram illustrating generally how the two filaments 116 and 118 in light bulb 114 are selectively activated. Power supply 122 provides load current through a normally closed protection switch 124 (for portable devices whose batteries must be recharged periodically) as will be explained hereafter. From protection switch 124, the circuit includes a fuse 125 in series with OFF/ON switch 16. A temperature selector switch 18 (explained in detail in relation to FIGS. 13-16) selects either one or both of the filaments 116 and 118 of light bulb 114. The filaments are of different resistance and construction (as is well known in the art) such that they have different resistances and one of them generates more heat than the other. Thus selector switch 18 may select both filaments 116 and 118 for HIGH heat, only filament 116 for MEDIUM heat, or only filament 118 for LOW heat.

FIGS. 13-15 illustrate generally how such a temperature selector switch 18 could be constructed. It is to be understood that other designs could be used so long as the same functions are achieved.

FIG. 13 illustrates the physical position of switch 18 when it is in the maximum heat position and BOTH filaments 116 and 118 are selected. Switch 18 has a body portion 126 shown in phantom lines that engages certain electrical contacts 138-148. All of the contacts 138-148 are permanently affixed and only the switch body portion 126, with its contact arms 128, 130, 132, and 134, moves with respect to contacts 138-148.

With the switch 18 body portion 126 in the position shown in FIG. 13, the power from the power source 122 (FIG. 11) is conducted from line 136 to contact 138. Switch contact arm 134 engages contact 138 and conducts power to contact 140 through contact arm 132. Contact 140 is connected to conductor 141 connected to filament #2. Thus, filament #2 is energized.

In the same switch position shown in FIG. 13, contact arm 128 of body portion 126 engages contact 142 that is permanently electrically connected to terminal or contact 144. In turn, contact 144 is connected to conductor 145 connected to filament #1. Thus, in the switch position shown in FIG. 13, both light bulb filaments #1 and #2 are energized and maximum (HIGH) heat is generated by the light bulb 114.

In the switch position shown in FIG. 14, contact arm 128 of switch body portion 126 is now directly connected to terminal 144 to energize light bulb filament #1. Contact arm 130 of switch body portion 126 is too short to contact terminal 140 and filament #2 is not energized. Thus, power flows from input line 136 to contact 138, to switch body contact arm 132, through the switch body 126 to contact arm 128 and contact 144 and from there to conductor 145 that is connected to filament #1. Thus, only filament #1 is energized and a MEDIUM heat is generated because filament #2 is not energized.

In the switch position shown in FIG. 15, power is connected from input line 136 to short contact arm 130, through the switch body 126 to contact arm 128, and through terminal or contact 140 on line 141 to filament #2. Thus, only filament #2 is energized and a LOW heat is generated because filament #2 generates the least heat because of its construction as is well known in the art.

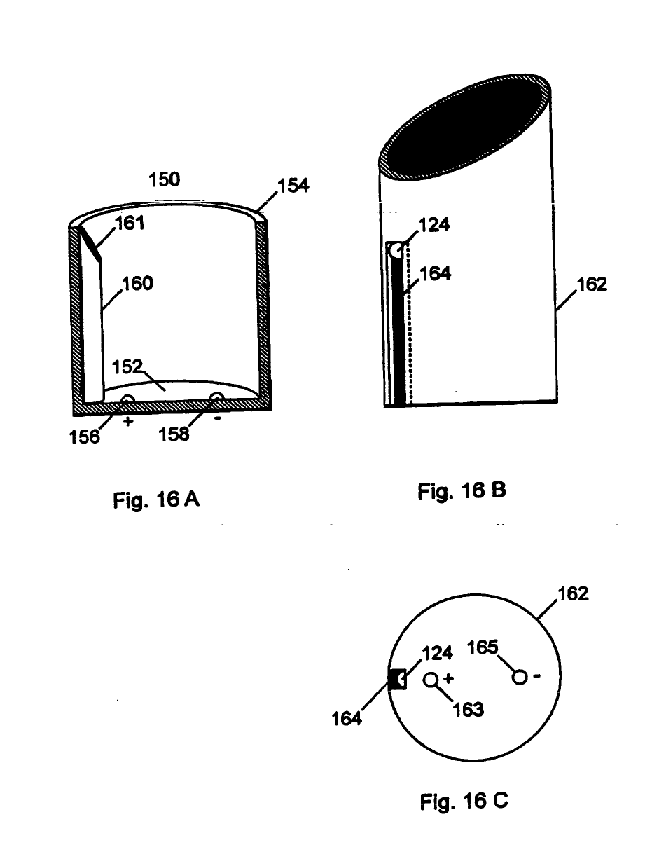

It is to be understood that while the invention has been disclosed herein has at least one battery located in the handle of the hair management device and can be charged therein without removing them, a single battery of the proper voltage may be used while a spare battery is charging in a charging unit. When needed, the battery in the handle can be simply removed and replaced with the battery in the charger. The battery taken from the handle may then be placed in the charger. A representative charging device for portable hair management devices of the present invention wherein the batteries in the handle are charged while in the handle is illustrated in FIGS. 16A, 16B, and 16C.

The charger 150 is shown in cross-section in FIG. 16A. It has a base 152 and cylindrical side wall 154 (that could be in any desired shape other than a cylinder). Electrical contacts 156 and 158 are formed in base 152 (for example only) to provide DC charging current in a well-known manner from a source as is well-known in the art and that will not be shown in detail here. The charger is of conventional construction except for an internal, longitudinal, projection on the inside of the charger 150 that has two functions. First, it mates with a corresponding slot 164 in the handle of the hair management device 162 (see FIG. 16B and FIG. 16C) so that it can be placed in the charger in only one position to assure proper polarity mating contact with DC terminals 156 and 158. Obviously, AC could be used to power the charger in any well know manner to cause DC to appear at the terminals 156 and 158.

The projection 160 has an upper surface 161 that may be rounded, sloped, or otherwise designed for its second function and that is to operate a protection switch 124 (see FIG. 16B and FIG. 16C) on the handle of the hair management device 162 when it is placed within the charger 150. This is the same switch 124 that is shown in FIG. 12. It is desirable that the battery (or batteries) in the hair management device NOT receive power (be charged) when the ON/OFF switch of the device is in the ON position and providing power to the heating element (light bulb) because of possible damage to the device 12. Thus switch 124 is normally in the closed position to couple power to the ON/OFF switch when the hair management device handle 162 is NOT placed in the charger.

When the device handle 162 is placed in the charger 150, projection 160 must fit in slot 164 in the handle 162 of the hair management device. This assures, first, that the polarity of the power contacts 156 and 158 in the charger is proper with respect to the corresponding power contacts 163 and 165 of the hair management device and, second, as the handle slides down into the charger, the projection 160 has an upper surface 161 that engages the normally closed protection switch 124 and forces it inwardly thus opening the switch 124 contacts and removing any power to the hair management device heating element even if the OFF/ON switch 16 is inadvertently left in the ON position thus protecting the device.

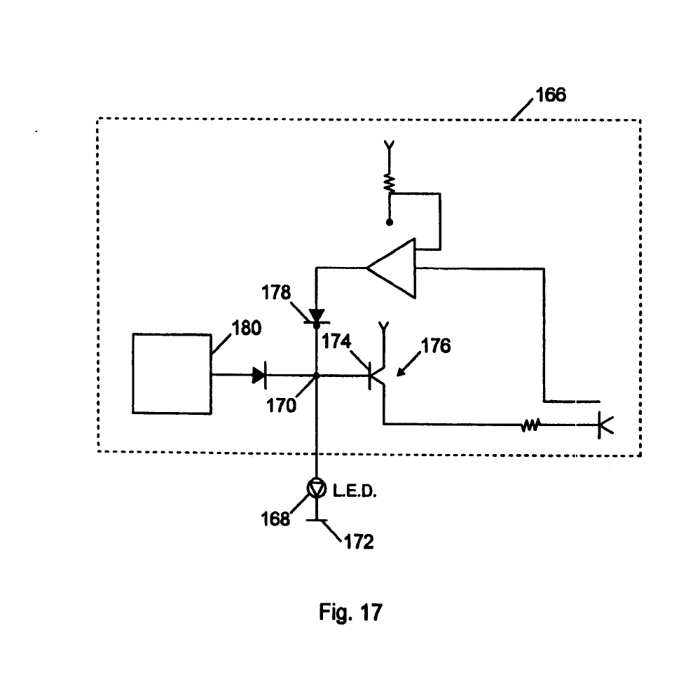

FIG. 17C is a bottom view of the device handle 162 to show slot 164 with protection switch 124 therein and the charging contacts 163 and 165 that mate with contacts 156 and 158 respectively in the base of the charger 150.

It is desirable that the user of the hair management device have a visual reminder when the power is applied to the device. Such a visual reminder can be a light emitting diode 168 such as shown in FIG. 17.

The circuit shown in FIG. 17 within the phantom lines 166 is the same circuit shown in commonly owned U. S. Pat. No. 6,449,874 that regulates the power applied to the load. In the present FIG. 16, a light emitting diode 168 is coupled between the ground terminal 172 and the base 174 of power transistor 176 as at junction 170. Until the time that the proper temperature of the device is reached, a constant voltage is applied to the base 174 of the power transistor 176. Thus, the LED 168 is ON continuously. However, when the proper temperature is reached, the output from inverting diode 178 ceases as explained in U.S. Pat. No. 6,449,874 and pulses from temperature regulating circuit 180 begin to control the operation of the power FET 176. These pulses cause the LED 168 to pulse accordingly. Thus, the LED provides a clear indication that power is being applied to the power FET 176.

When, and if, the light bulb 114 has a ceramic coating placed thereon as explained previously, the outer end of the bulb 114 may be left clear and not coated. An orifice may then be placed at any convenient place in the end of the cap on the outer end of the housing shown in FIGS. 1-4 and light will shine from the uncoated end of the bulb 114 and through the orifice to provide an indication that the bulb is functioning.

If for any reason the bulb 114 is not working, the rapid heating will not occur and therefore will also give an obvious indication of a bulb malfunction.

Thus, there has been disclosed a novel improved heating element and circuit and method for forming and operating a hair management device (preferably a portable device) such as a Curling Iron or a Hot Air Brush. The improved method and heating element uses a light bulb as a heat source because it heats and cools quickly. The light bulb may be incandescent or halogen. The halogen bulb heats much faster and to a higher temperature than the incandescent bulb. The light bulb is positioned within a hollow, elongated tube that is constructed of any type metal or material that can withstand heat. Preferably, the tube is formed of a material from the group consisting of brass, copper, ceramic, and aluminum. Also the thickness of the wall forming the tube is preferably in the range from about 0.010 inches to about 0.040 inches so that it can heat quickly and cool quickly.

A further novel feature and method of the invention is the use of an elongated tube that is perforated with small holes or orifices, preferably in a uniform pattern to allow radiant energy from the heat source to reach the hair, not just the conductive heat.

The light bulb or heat source may be coated with a ceramic material that will conduct heat while giving the light bulb additional structural integrity to reduce the possibility of breaking or shattering when an unintentional physical force is applied to the hair management device.

As a further novel feature and method of the invention, the light bulb heating source is removable and replaceable (in any well-known manner such as by a screw type base or a bayonet type base). In addition, to facilitate removal and replacement of the light bulb, the elongated heat transfer tube may be removably associated with the handle portion that contains the power supply and control circuits. This will expose the light bulb so that it can be removed and replaced.

The method allows a portable unit to be made rechargeable by forming contacts on the base of the handle and placing the unit in a charging station having comparable contacts or supplying a magnetic field such as used in charging portable telephones, electronic toothbrushes, and the like. The novel method also allows the novel elongated halogen light bulb to be used in existing 110 volt devices that are not portable.

The unique heating circuit and method of forming it prolongs battery life (as well as the life of a heat source, especially a light bulb) by applying full power to the heating source or light bulb until the desired temperature of the unit is obtained and then the power applied is automatically reduced with a simple circuit to an amount just sufficient to maintain the desired temperature. In the preferred embodiment, this may be accomplished by placing a normally closed bimetallic temperature switch across the control circuit (in parallel) to ground thus applying full power to the heating element. This enables rapid heating of the heating element. When the predetermined temperature of the bimetallic switch is reached, the switch opens and allows the control circuit to govern the amount of power applied to the heating element. In actual tests, the applied power was reduced as low as 10% of the maximum power while maintaining the desired heat thus prolonging the life of the batteries and of the light bulb.

A second bimetallic switch may be used in a well-known manner to provide a convenient protection circuit for the unit. Placing such second bimetallic switch between the load (light bulb) and the power FET will not allow the temperature of the load to exceed the predetermined temperature at which the bimetallic switch is set and at which it will open. This limits the temperature the load (light bulb) can reach as a safety precaution.

While the preferred embodiments have been shown and described, various modifications and substitutions may be made thereto without departing from the spirit and scope of the invention. Accordingly it is to be understood that the present invention has been described by way of illustration and not limitation.

The corresponding structures, materials, acts, and equivalents of all means or step plus function elements or method steps in the claims below are intended to include any structure, material, or act for performing the function in combination with other claimed elements as specifically claimed.

1. An improved heating element and circuit for a user held portable hair management device comprising:
a hollow non-heat conductive handle having a base portion and a top portion;
an elongated heat transfer hollow tube in the-shape of a hollow cylinder and having an interior portion, an outer end, and an inner end, the inner end of the hollow tube being coupled to the top portion of the handle;
the elongated heat transfer hollow tube having a circular wall, the circular wall having a thickness in the range of about 0.010 inches to about 0.040 inches and being formed of one of the group consisting of brass, copper, ceramic, and aluminum;
a DC power supply;
at least one light bulb in the interior of the elongated heat transfer hollow tube to receive load current from the DC power supply and to serve as a heat source; and
an ON-OFF switch coupled between the DC power supply and the light bulb for selectively coupling the power supply to the light bulb to generate heat that is transferred to the elongated heat transfer hollow tube.

2. The improved heating element and circuit of claim 1 further comprising:
at least one battery in the hollow handle for forming a source of DC power;
electrical connectors on the base of the hollow handle for recharging the at least one battery therein;
a charger having an opening for receiving at least a portion of the handle of the portable hair management device;
mating connectors in the charger for connection to the handle electrical connectors for recharging the at least one battery therein; and
a normally closed protection switch coupled between the battery and the OFF/ON switch for automatically opening when at least a portion of the handle of the hair management device is placed in the charger so as to prevent power from being supplied to the heat source during the charging of the at least one battery even if the OFF/ON switch is left in the ON position.

3. The improved heating element and circuit of claim 2 further comprising:
a groove on the outside of the hollow handle;
the normally closed protection switch being positioned with the handle groove; and
an actuating device in the charger for automatically opening the normally closed protection switch when the hollow handle portion is placed within the charger.

4. The improved heating element and circuit of claim 3 wherein the actuating device further comprises:
an elongated projection with the charger opening that mates with the groove on the outside of the hollow handle when the handle portion is inserted in the charger opening thereby requiring that the device handle be inserted in the charger opening in only one position to enable proper engagement between the electrical connectors in the charger and the electrical connectors on the base of the handle; and
at least a portion of the elongated projection engaging and automatically electrically opening the normally closed protection switch when the hollow handle portion is placed within the charger opening.

5. The improved heating element and circuit of claim 1 further comprising:
a plurality of perforations in at least a portion of the hollow cylinder to enable radiant energy from said heat source to be transferred to the hair of the user.

6. The improved heating element and circuit of claim 5 wherein the plurality of perforations in the hollow cylinder forms a uniform pattern on the hollow cylinder.

7. The improved heating element and circuit of claim 1 further comprising:
an outer coating plated on the hollow cylinder for esthetic purposes.

8. The improved heating element and circuit of claim 7 wherein the outer coating is formed of one of the group consisting of chromium, ceramic, and enamel.

9. The improved heating element and circuit of claim 1 wherein said at least one light bulb is a single elongated, pencil type, halogen light bulb having an outer end and an inner end.

10. The improved heating element and control circuit for a hair management device as in claim 9 further comprising:
multiple filaments in the elongated pencil type light bulb, each filament having a different power requirement; and
a temperature selection switch coupled to the elongated pencil type light bulb for selectively coupling power to both filaments to select a HIGH temperature, to either of the filaments to select a MEDIUM temperature, or to the other one of the filaments to select a LOW temperature.

11. The improved heating element and circuit of claim 9 further comprising:
a shock absorbing element associated with the single elongated light bulb to reduce the possibility of shattering the at least one light bulb when a physical shock is applied to the heat transfer hollow tube.

12. The improved heating element and circuit of claim 11 wherein the shock absorbing element comprises:
a cap removably attached to outer end of the elongated heat transfer hollow tube;
a first resilient device associated with the cap for engaging the outer end of the single elongated light bulb; and
a second resilient device associated with the inner end of the single eleongated light bulb thereby holding the single light bulb in a resilient relationship with the elongated heat transfer hollow tube to aid in protecting the single light bulb from physical shock.

13. The improved heating element and circuit of claim 1 wherein said DC power supply comprises:
at least one battery; and
a voltage control circuit coupled between the OFF-ON switch and the at least one light bulb for supplying power to the at least one light bulb to obtain substantially a desired maximum temperature and then limiting the power applied sufficient only to maintain the desired temperature thereby extending the life of the at least one battery and the at least one light bulb.

14. The improved heating element and circuit of claim 13 further comprising:
a bimetallic temperature sensor switch that opens at a desired predetermined temperature coupled in parallel with the voltage control circuit to cause rapid heating of the at least one light bulb until the bimetallic switch opens thereby causing the voltage control circuit to begin to limit the power supplied to the light bulb sufficient to only maintain the desired temperature.

15. The improved heating element and circuit of claim 14 wherein the voltage control circuit further comprises:
a comparator having first and second inputs and an output;
a heat sensor located in heat sensing proximity with the at least one light bulb for generating an output signal proportional to the sensed heat;
the heat sensor output signal being coupled to the first comparator input;
a reference voltage generator having an output signal coupled to the second comparator input such that the comparator produces an output signal only in the time period during which the heat sensor output signal at the first comparator input is greater in amplitude than any portion of the reference signal at the second comparator input;
an electronic switch coupled between the comparator output and the at least one light bulb; and
wherein the comparator output signal turns the electronic switch ON only during the time the heat sensor signal amplitude to the comparator is greater than any portion of the reference signal amplitude to the comparator and turning the electronic switch OFF during the time when the heat sensor signal amplitude to the comparator is less than any portion of the reference signal amplitude being coupled to the comparator.

16. The improved heating element and circuit of claim 15 wherein the electronic switch is a semiconductor capable of carrying required load current to be delivered to the at least one light bulb.

17. The improved heating element and circuit of claim 15 wherein the semiconductor switch is a power FET.

18. The improved heating element and circuit of claim 15 wherein the heat sensor is one of the group consisting of a thermistor and a tempistor.

19. The improved heating element and circuit of claim 1 further comprising:
a ceramic coating on at least a portion of the at least one light bulb to enable heat transfer while providing structural integrity to the at least one light bulb and to assist in reducing the possibility of shattering the at least one light bulb when unexpected physical shock is applied to the heating element.

20. An improved heating element and circuit for a user held hair management device comprising:
a hollow non-heat conductive handle having a base portion and a top portion;
an elongated heat transfer hollow tube having an interior portion, an outer end, and an inner end, the inner end of the hollow tube being coupled to the top portion of the handle;
a power supply for providing load current;
a heat source in the interior of the elongated heat transfer hollow tube to receive load current from the power supply;
the elongated hollow tube comprising a hollow cylinder having an outer surface and being formed of one of the group consisting of brass, copper, ceramic, and aluminum; and
wherein the hollow cylinder has a preferred thickness in the range of about 0.010 inches to about 0.040 inches.

21. The improved heating element and circuit of claim 20 further comprising:
a plurality of perforations in at least a portion of the hollow cylinder to enable radiant energy from the heat source to be transferred to the hair of the user.

22. The improved heating element and circuit of claim 20 wherein the power supply comprises:
an AC power supply; and
a voltage control circuit coupled between the OFF-ON switch and the heat source for supplying power to the heat source to obtain a desired temperature and then limiting the power applied sufficient only to maintain the desired temperature thereby extending the life of the heat source.

23. The improved heating element and circuit of claim 22 further comprising:
a bimetallic temperature sensing switch that opens at a desired predetermined temperature coupled in parallel with the voltage control circuit to cause rapid heating of the heat source until the bimetallic switch opens thereby causing the voltage control circuit to begin to limit the power supplied to the heat source sufficient to only maintain the desired temperature.

24. The improved heating element and circuit of claim 23 wherein the voltage control circuit further comprises:
a comparator having first and second inputs and an output;
a heat sensor located in heat sensing proximity with the heat source for generating an output signal proportional to the sensed heat;
the heat sensor output signal being coupled to the first comparator input;
a reference voltage generator having an output signal coupled to the second comparator input such that the comparator produces an output signal only during the time period in which the heat sensor output signal at the first comparator input is greater in amplitude than any portion of the reference signal at the second comparator input;
an electronic switch coupled between the comparator output and the heat source; and
wherein the comparator output signal turns the electronic switch ON only during the time the heat sensor signal amplitude to the comparator is greater than any portion of the reference signal amplitude to the comparator and turns the electronic switch OFF only during the time when the heat sensor signal amplitude to the comparator is less than any portion of the reference signal amplitude being coupled to the comparator.

25. The improved heating element and circuit of claim 24 wherein said heat sensor is one of the group consisting of a thermistor and a tempistor.

26. The improved heating element and circuit of claim 20 wherein the heat source is an elongated, pencil type, halogen light bulb.

27. The improved heating element and circuit of claim 20 wherein said hollow non-heat conductive handle and coupled elongated heat transfer hollow tube form a hair curling iron.

28. The improved heating element and circuit of claim 20 further comprising;
an air blower located in said handle;
a hollow brush attachment having bristles extending perpendicular to the attachment; and
said hollow brush attachment being placed over said elongated heat transfer hollow tube in a selectively rotatable manner to form a hot air brush.

29. The hot air brush of claim 28 further comprising a plurality of orifices in said hollow brush attachment to allow heat energy from said at least one light bulb to exit.

30. An improved heating element and circuit for a hair management device comprising:
a hollow non-heat conductive handle:
an elongated heat transfer hollow tube having an interior portion and being coupled to the hollow non-heat conductive handle;
a heat source located within the elongated heat transfer hollow tube;
a plurality of perforations in at least a portion of the hollow heat transfer tube to enable radiant heat to escape from the heat source externally of the hollow heat transfer tube;
a power supply; and
an ON-OFF switch coupled between the power supply and the heat source for selectively coupling the power supply to the heat source to generate radiant energy as well as conductive heat that is transferred to the elongated heat transfer hollow tube.

31. The improved heating element and circuit of claim 30 wherein the perforations are of substantially uniform spacing.

32. A method of forming an improved heating element and circuit for a hair management device and comprising the steps of:
forming said hair management device with a handle and an attached elongated hollow heat transfer tube;
forming an outer surface on the elongated hollow heat transfer tube with a plurality of perforations in the outer surface to enable radiant energy from the heat source to be transferred to the hair of the user;
inserting a single elongated, pencil type, light bulb inside the hollow heat transfer tube as a heat source;
coating the light bulb with a ceramic coating to create greater structural integrity and to reduce the possibility of shattering of the light bulb when a physical shock is applied to the hair management device;
powering the at least one light bulb with a power supply;
coupling an ON/OFF switch between the at least one light bulb and the power supply for selectively coupling power to the at least one light bulb to cause the at least one light bulb to act as a heat source for the hollow heat transfer tube; and
heating the heat transfer tube with maximum applied power from the power supply only until a desired temperature is reached and then automatically reducing the applied power sufficient only to maintain the desired temperature thereby prolonging battery life and light bulb life.

33. The method of claim 32 further comprising the steps of:
placing a heat sensor in heat sensing relationship with the heat source;
generating a signal with the heat sensor that is proportional to the heat source temperature; and
coupling a control circuit to the heat sensor to reduce the power applied to the heat source sufficient only to maintain the desired temperature.

34. The method of claim 33 further comprising the step of:
placing the heat sensor at a sufficient distance from the heat source to allow the heat source to substantially attain a desired temperature before the heat sensing device begins to generate the signal that is proportional to the heat source temperature.

35. The method of claim 32 further comprising the steps of:
regulating the heating generated by the heat source with a control circuit; and
coupling a bimetallic temperature sensor switch, that opens at a desired predetermined temperature, in parallel with the control circuit to cause rapid heating of the light bulb until the bimetallic switch opens thereby causing the control circuit to begin to regulate the power supplied to the light bulb sufficient only to maintain the desired temperature.

36. The method of claim 32 wherein the step of inserting a single, elongated, pencil type light bulb in the heat transfer tube further comprises the step of using a halogen bulb as the light bulb.

37. An improved heating element and circuit for a device comprising:
an electrical load associated with the device that changes temperature with power applied, to the electrical load comprising a single, elongated halogen light bulb;
a power supply;
an electrical switch for selectively coupling the power supply to the electrical load;
a heat sensor in heat exchange relationship with the electrical load for generating an output signal substantially proportional to the heat of the electrical load;
a reference voltage; and
a control circuit for receiving the heat sensor output signal and the reference signal and generating an output signal to the electrical switch so as to enable the electrical load to reach a predetermined desired temperature and then limit the power applied to the electrical load only sufficient to maintain the predetermined desired temperature.

38. The improved heating element and circuit of claim 37 wherein the control circuit further comprises:
a comparator having first and second inputs and an output;
the output signal of the heat sensing element being coupled to the first comparator input;
the reference voltage being coupled to the second comparator input; and
the comparator generating an output signal to the electrical switch only during the time period during which the output signal of the heat sensing element at the first comparator input is greater in amplitude than any portion of the reference signal at the second comparator input.

39. The improved heating element and circuit of claim 38 wherein the reference voltage is a sawtooth waveform.

40. The improved heating element and circuit of claim 38 wherein the reference voltage is a sine wave.

41. The improved heating element and circuit of claim 37 further comprising:
multiple filaments in the elongated pencil type light bulb, each filament having a different power requirement; and
a temperature selection switch couple to the elongated pencil type light bulb for selectively coupling power to both filaments to select a HIGH temperature, to one of the filaments to select a MEDIUM temperature, and to the other one of the filaments to obtain a LOW temperature.

42. An improved heating element and control circuit for a hair management device consisting of:
a handle coupled to a hollow heating tube;
the hollow heating tube being formed of a material taken from the group comprising brass, copper, ceramic, and aluminum;
a power supply;
an elongated pencil type halogen light bulb located within the hollow heating tube as a heat source;
at least two filaments in the light bulb; and
a temperature selection switch coupled between the power supply and the light bulb filaments for selectively applying power to both of the at least two filaments to obtain a HIGH temperature or to a first one of the at least two filaments to obtain a MEDIUM temperature or to the other second one of the at least two filaments to obtain a LOW temperature.
